(19) United States
(12) Patent Application Publication
(10) Pub. No.: US 2002/0075906 A1
(43) Pub. Date: Jun. 20, 2002

(54) Signal transmission systems

(76) Inventors: Steven R. Cole, Andover (GB); David Connolly, St. Albans (GB); Nigel A. Summers, Christchurch (GB)

Correspondence Address: SCHWEGMAN LUNDBERG WOESSER & KLUTH, 1600 TCP TOWER, 121 SOUTH EIGHTH STREET, MINNEAPOLIS, MN, 55402, US

(21) Appl. No.: 09/780,961

(22) Filed: Feb. 9, 2001

(30) Foreign Application Priority Data
Dec. 15, 2000 (GB) 0030691.0

(51) Int. Cl. H04J 3/04

(52) U.S. Cl. 370/535

(57) ABSTRACT

Signal transmission systems for second and third generation mobile communications networks are described. A signal distribution system comprises a plurality of rf transmitters for serving a plurality of network cells. The system is characterised by a multiplexer coupled to the transmitters for multiplexing the transmitter outputs, a signal transporter for transporting the multiplexed signals to each of the network cells, and a multiplexed signal receiver at each cell for selecting and receiving a signal from a transmitter serving the cell. The invention also provides a complementary signal reception system, and corresponding methods. Preferably, the multiplexed signals are transported over a fibre optic network such as an existing cable TV network. The system simplifies the deployment of network infrastructure for third generation mobile communications systems.

### FIELD OF THE INVENTION

This invention is concerned with the transmission of signals between elements of a cellular communications network, such as a GSM network or an IMT-2000 network. More particularly it relates to the transmission of signals between transmitters and/or receivers serving cells in the network and antennas at the cells themselves. Aspects of the invention provide a system for distributing signals from a plurality of such transmitters to a plurality of cells and a system for receiving signals from a plurality of cells and transmitting these signals to a plurality of receivers.

### BACKGROUND TO THE INVENTION

FIG. 1 shows an overview of one type of cellular communications network, a GSM (Global System for Mobile communications) network 100. Referring to FIG. 1, a plurality of Base Transceiver Stations (BTS) 102 are coupled to a Base Station Controller (BSC) 104 by digital links 106 across the so-called A_{bts} interface. Each BTS 102 is provided with an antenna (or set of antennas) 108 for serving its respective cell. In FIG. 1 a Mobile Station (MS) 110 is located in Cell 1 and communicates with the BTS serving that cell. Both the Base Transceiver Station 102 and the mobile station 110 incorporate radio frequency (rf) transceivers to allow the mobile station 110 to transmit and receive voice and data traffic over the GSM network. The Base Transceiver Station defines a cell and manages the protocols for RF communication with the mobile station across the air interface, also known as the Um interface.

As illustrated in FIG. 1, a single BTS is provided for each cell but, in practice, two or more BTS's may be provided for each cell, depending upon the number of anticipated simultaneous users in that cell. Each BTS normally comprises a plurality of transceivers, typically six for a tri-sectored GSM cell, two for each sector. Each transceiver provides a frequency channel comprising 8 traffic channels, for serving up to 8 mobile stations. In the GSM system communication between the BTS and the mobile station uses a combination of TDMA (Time Division Multiple Access) and FDMA (Frequency Division Multiple Access). The frequency spectrum allocated to the network is divided into a plurality of carriers to implement FDMA and each carrier is divided into a plurality of TDMA frames to define the traffic channels.

In Europe, GSM operates at around 900 MHz (the frequency ranges 890-915 MHz and 935-960 MHz are allocated to mobile communications networks) and according to the GSM FDMA scheme the FDMA carriers are spaced at 200 KHz, to occupy a maximum of 25 MHz (with 124 carriers). An equivalent system, DCS 1800, operates at approximately 1.8 GHz, and in North America GSM (and the equivalent PCS 1900 system) operates at 1.9 GHz.

As shown in FIG. 1, a plurality of Base Transceiver Stations are coupled to a single Base Station Controller (BSC) 104. Elsewhere in the system other Base Transceiver Stations 102′ are coupled to other Base Station Controllers, such as BSC 104′. The Base Station Controller controls a plurality of Base Transceiver Stations, normally in a plurality of different cells, and, among other things, manages handovers (or handoffs) of the mobile station between cells and between different channels in a single cell. The BSC also manages other channel set up and control functions. Thus, for example, the Base and Mobile stations generally hop between different frequencies during a single TDMA frame for transmit, receive and monitor functions, and also hop between frequencies on TDMA frame changes. The Base Station Controller manages this frequency hopping as well as other functions, such as transmit power control.

Each Base Station Controller 104, 104′ is connected via a digital link to a Mobile Switching Centre (MSC) 112 which in turn is connected to the Public Switched Telephone Network (PSTN) 116 and/or the Integrated Services for Digital Network (ISDN) (not shown). Mobile switching centre 112 is also coupled to a plurality of databases 114, including a Home Location Register (HLR) and a Visitor Location Register (VLR) to provide call-routing and roaming functions, and an Equipment Identity Register (EIR) and an Authentication Centre (AuC) for mobile station identification, authentication, and security. Generally MSC 112 will also be coupled to other MSCs over a high bandwidth digital network, such as (Synchronous Transfer Mode) STM-16/64. For further details of the GSM specification, reference may be made to the GSM standards published by ETSI (the European Technical Standards Institute), including standards GSM 01-12 which are hereby incorporated by reference.

As illustrated in FIG. 1, in a cellular communications network the physical area covered by the network is divided into cells. A given physical area will normally receive coverage from two or more network operators, each of which will have their own system of Base Transceiver Stations. A Mobile Station incorporates a Subscriber Identity Module (SIM) which allows a user of the mobile station access to the network of a particular operator and which specifies the services, such as speech and data services, to which the user has subscribed. However, the GSM hardware such as the Base Transceiver Stations and GSM terminals (or “Mobile Equipment”) into which the SIM cards are inserted, is generally not operator-specific and is usable with any GSM network. An operator normally restricts access, by means of data stored on the SIM cards, to the networks of other operators for commercial rather than technical reasons.

The above described cellular communications network is a so-called “2G” or second generation system. Later systems are referred to as 2.5G and 3G (third generation) communication systems. These are also cellular communications systems although they may be based on packet switched data services such as GPRS (General Packet Radio Service) rather than a circuit switched network approach. The invention described below is suitable for use with either type of cellular communications network.

Referring now to FIG. 2, this shows a prior art in-building signal distribution system 200 for distributing base station transceiver signals in a GSM communications network. In FIG. 2 a shopping centre 202 comprises a so-called “pico” cell—that is it forms a cell of its own within a physically larger, conventional mobile communications network cell. Such an arrangement helps manage network traffic where a large number of users is concentrated within a single building. The pico cell is served by one or more Base Transceiver Stations separately from the larger conventional cell (which may be termed a macro cell) within which it is sited. In the signal distribution system of FIG. 2, the pico cell of shopping centre 202 is shared between a number of operators—that is the physical area of the pico cell is served by dedicated Base Transceiver Stations of more than one operator.

In more detail, Base Transceiver Stations 204 and 206 are coupled to first and second GSM networks managed by first and second GSM network operators, operating at 900 MHz. Base Transceiver Stations 208 and 210 are coupled to third and fourth GSM-type networks operating at 1800 MHz and managed by respective third and fourth network operators. Each Base Transceiver Station receives a digital E1 (2 Mbps) data feed, coupling the BTS to its Base Station Controller.

The RF input/outputs of BTS 204 and 206 are coupled to RF combiner/splitter 212, together with the RF input/outputs of any further Base Transceiver Stations operating at 900 MHz. Similarly, the RF interfaces of Base Transceiver Stations 208 and 210 are coupled to RF combiner/splitter 214 operating at 1800 MHz. The RF combiner/splitters operating at 900 MHz and 1800 MHz are preferably separate to reduce the risk of a second harmonic of the 900 MHz signals interfering with the 1800 MHz signals.

Each combiner/splitter accepts two or more RF output signals from the Base Transceiver Stations and combines these into a single rf output, for example by simple simulation. Each combiner/splitter also accepts a single RF input, for example from a cell antenna, and separates this into two or more received signals provided as RF outputs to the Base Transceiver Station RF inputs. Since the Base Transceiver Stations are configured to select, from a plurality of signals received at an RF receive antenna, only those signals which are intended for processing by the BTS, the RF “separator” need only duplicate the signal received at its RF input to a plurality of outputs for the Base Transceiver Stations. Thus the “splitter” need only provide a fan-out function, and could be referred to as an RF separator.

As illustrated, each combiner/splitter has a plurality of first interface lines, one for each Base Transceiver Station it interfaces to, and a second interface with a single interface line for interfacing, directly or indirectly, to a cell antenna. Both sets of interface lines are input-output lines. The first interface lines are coupled to inputs of a combiner module of the combiner/splitter and to outputs of a splitter module of the combiner/splitter. The second interface line is coupled to an output of the combiner module and an input of the separator module.

The second interface lines of combiner/splitters 212 and 214 are coupled to a further combiner/splitter 216 which operates with signals at both 900 MHz and 1800 MHz. Such devices are available from, for example, Aerial Facilities Limited and Remec, in the UK. The single second interface line of combiner/splitter 216 then provides a coaxial cable feed to a plurality of cell antennas 218, 220 and 222 positioned at points within the pico cell chosen to ensure good coverage throughout the cell. In practice, antennas 218, 220 and 222 may each comprise separate transmit and receive antennas or a combined transmit/receive antenna. Antennas 218, 220 and 222 are dual band antennas for operation at both 900 and 1800 MHz but, in other embodiments, may comprise separate antennas for the 900 MHz and 1800 MHz frequency bands. In this way a mobile station such as GSM hand set 224, within the pico cell may be provided with coverage for two or more GSM network operators. Further components of the system, such as RF duplexers and preamplifiers, which may also be employed in practical embodiments of the system, are not shown in FIG. 2.

In the system of FIG. 2, the cable run between combiner/splitter 216 and antennas 218, 220 and 222 may be several hundred meters, in which case signals received at the antennas may be lost and signals for transmission by the antennas may be severely attenuated. FIG. 3 shows prior art equipment 300 which may be used in such circumstances to provide longer cable runs than could otherwise be tolerated.

In FIG. 3a combiner/splitter 302 provides an RF output on co-axial cable to an rf-optical converter 304, which in turn is coupled or connected to a first end of fibre optic cable 306. The rf-optical converter 304 converts an input rf signal to an optical output signal for fibre optic cable 306 and converts an optical input signal from fibre optic cable 306 to an rf output signal for input to combiner/splitter 302. A second end of fibre optic cable 306 is connected to optical-Category 5 converter 308 which provides a Cat 5 cable connection to Cat 5-rf converter 310 which provides a coaxial cable connection to antenna 312. A problem with this system is, however, that it is only able to serve a single antenna and a separate fibre optic cable connection is required for each separate antenna 312.

The Cat 5 cable run is typically 60 to 90 meters whilst the fibre optic cable run may be up to 1 kilometer for multimode fibre and greater than 1 kilometer for single mode fibre. Fibre optic cable 306 is shown as a single connection between converters 304 and 308, but in practice it will normally consist of a pair of optical fibres, one to provide an uplink connection from the antenna 312 and the other to provide a downlink connection to the antenna 312. Equipment of the type shown in FIG. 3a is available from LGC Wireless Inc., San Jose, USA and/or Tekmar Sistemi, Italy.

Third generation (3G) mobile communications networks are briefly mentioned above. The third generation standard is known as the International Mobile Telecommunications or IMT-2000 standard and is available from the International Telecommunications Union (ITU), for example via www.itu.int, and a copy of this standard is hereby incorporated by reference.

Unlike GSM, the third generation technology uses CDMA (Code Division Multiple Access) rather than TDMA with, in Europe, the USA and Japan, FDD (Frequency Division Duplex) operation for the up and down links from and to the Mobile Station. Europe and Japan use wide band (W) CDMA with direct spread FDD whilst the USA uses cdma2000 with multi-carrier FDD.

Broadly speaking, the architecture of third generation systems is similar to that of the GSM system shown in FIG. 1. Thus a Radio Network Controller (RNC) replaces the Base Station Controller (BSC) and a so-called Node B replaces the Base Transceiver Station (BTS). The RNC performs similar functions to the BSC but includes support for packet data handling, as well as support for legacy (2G and 2.5G) systems. Third generation networks will also incorporate additional systems, not shown in FIG. 1, such as Media Gateways (MGW), Serving GPRS Support Nodes (SGSN) and Gateway GPRS Support Nodes (GGSN). The 3G systems comprise a radio access network coupled to a core network by a backbone network using asynchronous transfer mode (ATM) and/or internet protocol (IP) such as IP over SONET/SDH rings, which provide a high bandwidth, for example, by operating using Dense Wavelength Division Multiplexing (DWDM). Since code domain access is used in 3G systems Node B transceivers in adjacent cells may operate on the same or overlapping frequencies. Thus a single Node B may serve more than one cell.

The planned European WCDMA systems have at least a nominal 2×5 MHz bandwidth for each operator and the European Telecommunications Standard Institute (ETSI) has allocated the frequency bands of 1920-1980 MHz and 2110-2170 MHz for FDD operation. More generally, third generation systems are being implemented between 1 GHz and 3 GHz. In the UK five licences have been issued by the Government for third generation cellular telecommunications networks allocating 60 MHz of spectrum, three operators being provided with two 5 MHz FDD WCDMA channels, and two operators being provided with three 5 MHz channels.

From a user's perspective, the main feature of IMT-2000 is that it is intended to provide much greater data rates than 2G and 2.5G networks. Thus the standard specifies predefined user data rates of, for example, 144 Kbps and 384 Kbps up to 2 Mbps. The main way in which these relative high data rates are to be achieved when operating at around 2 GHz is by making the cells very much smaller than those of 2G systems. The consequence of this is that very many more cells are needed for a 3G system than for a 2G system. This results in a number of problems.

Installing a 3G network can have a significant detrimental effect on the environment as a large number of antenna sites is required for the smaller, more numerous cells, especially because the required number of sites is multiplied by the number of different network operators (in the UK, five). A related problem is the possible radiation hazard associated with the increased power transmission from antennas at these sites. Acquiring sites for these new antennas is expected to be difficult and expensive and, more generally, large capital and operational costs are expected to be associated with 3G networks. Maintenance of base station equipment for such a large number of cells, and upgrading such networks to provide increased capacity, is also likely to be time consuming and expensive.

### SUMMARY OF THE INVENTION

The present invention aims to address these and other problems associated with 2G, 2.5G, and particularly 3G cellular communications networks.

According to a first aspect of the present invention there is therefore provided a signal distribution system for distributing wireless communications network signals, the system comprising a plurality of rf transmitters for transmitting rf signals to serve communications devices in a plurality of network cells or sectors; and characterised in that the system further comprises a multiplexer, coupled to the rf transmitters, for multiplexing output signals from the transmitters and outputting a multiplexed transmitter signal; a signal transporter, coupled to the multiplexer, for transporting the multiplexed transmitter signals to each of the network cells or sectors served by the transmitters; and a multiplexed signal receiver at each served cell or sector, coupled to the signal transporter, for selecting and receiving a transmitter signal from an rf transmitter serving the cell or sector from the multiplexed transmitter signal.

By multiplexing the outputs from a plurality of base station transmitters and transporting the multiplexed signal to each served cell or sector the location of base station equipment for a number of cells or sectors can be centralised at a location remote from the cell or sector antenna site or sites. Here a cell refers to a geographical region of coverage and thus the system is usable to distribute signals to serve separate (cell) sectors conventionally provided with coverage from a single physical location (“cell site”).

At the antenna sites the multiplexed signal is converted back to an rf signal and transported, for example by means of co-axial cable, to a suitable antenna support such as a lamp post or building. The converter equipment is much smaller than the conventional Base Station Transmitter equipment, and also requires less power. It is therefore feasible in embodiments of the system to locate the converter equipment in roadside cabinets similar to those used for existing cable TV applications. This greatly simplifies the selection of sites for cell antennas, and facilitates the installation of equipment for a network with a large number of very small cells. Furthermore, the larger number of antenna locations possible together with their discreet street-level citing allows transmit power levels to be reduced. The environmental impact of a roadside cabinet is also significantly less than a conventional base station comprising a fenced-off mast and physically substantial enclosures for base station equipment.

Remotely siting the base station equipment also permits much faster deployment of cellular network equipment in urban and suburban areas, as well as simplifying maintenance and reducing maintenance and other operational costs. For similar reasons, capital investment costs can also be significantly lower than with conventionally served networks. The system also provides a scaleable architecture, simplifying the addition of Base Station Transmitters to a network as needed. The signal distribution system can be used with any cellular mobile communications network and is also applicable to networks intended to serve stationary devices, for example in indoor environments.

In another aspect the invention provides a signal reception system for receiving wireless communications network signals, the system comprising at least one rf receiver for receiving rf signals from communications devices in a plurality of network cells or sectors served by the receiver; and characterised in that the system further comprises a signal transporter for transporting signals from each served cell or sector to a demultiplexer; a cell or sector signal transmitter at each cell or sector, coupled to the signal transporter, for receiving a signal from a communications device in the cell or sector and for transmitting a cell or sector signal onto the signal transporter to make up at least part of a multiplexed cell or sector signal on the signal transporter; and a demultiplexer, coupled to the signal transporter and to the rf receiver, for demultiplexing the multiplexed cell or sector signal on the signal transporter and for outputting a plurality of demultiplexed cell or sector signals to the rf receiver.

The signal reception system operates in a broadly corresponding manner to the above described signal distribution system, multiplexing signals received at cell or sector antennas onto a signal transporter which transports signals from a plurality of cells or sectors back to a common point, at which receiver base station equipment is housed. In a CDMA system only a single receiver is needed to serve a plurality of cells or sectors but where traffic is heavy it may be preferably to employ a plurality of receivers for the plurality of cells or sectors.

The signal distribution signal and the signal reception system may be deployed independently of one another, for example by making use of conventional base stations to provide a respective reception or transmission function from or to a mobile communications device, but preferably the signal distribution system also operates to receive signals from mobile devices and the signal reception system also operates to distribute signals for transmission to mobile devices. Thus the signal distribution system preferably distributes signals for radio frequency transceivers by distributing both multiplexed transceiver output signals and multiplexed signals for input to the transceivers. In such a system a cell may be provided with a combined transmit/receive antenna or antenna array or may be provided with separate transmit and receive antennas. The skilled person will be aware of the many other alternatives available for GSM, 2.5G, and 3G antenna systems such as, for example, polarity diversity antennas. In preferred embodiments the transceivers comprise part of one or more GSM or IMT-2000 networks.

Preferably, the transmitters/receivers/transceivers all share a common digital interface, further reducing the requirements for a physical network infrastructure. The common digital interface may be provided by, for example, a switch and/or router. In this way only a single physical digital network connection, such as a fibre optic cable connection, need be provided for a plurality of transceivers, whether they are connected to a single BSC/RNC, or to different BSCs/RNCs. Such a single physical interface may even be utilised to provide a common interface to transceiver equipment belonging to two or more network operators since the switch/router can be used to direct network control signals and traffic of each operator to transceiver equipment on those operators' networks.

Preferably, the signal transporter comprises a fibre optic cable, as this allows the re-use of existing cable infrastructure, such as fibre optic cable installed to provide cable TV services. However, in other embodiments the multiplexed transmitter/receiver/transceiver signals may be transported by, for example, co-axial cable and/or microwave links. Re-use of existing fibre optic cable networks can be achieved by, for example, selecting a wavelength or wavelengths for the cellular network traffic which is or are different to those already in use by, for example a cable TV network.

A further advantage of the use of fibre optic cable is the relative ease with which such a system can be scaled to increase the traffic capacity provided to the cell transmission and/or reception sites to allow future upgrade of a network, for example to take account of increased use of data hungry applications such as video transmission/reception.

In embodiments where the signal distribution system is used to transport both multiplexed transmitter signals and multiplexed cell signals for cell transceivers, the fibre optic cable preferably comprises a pair of optic fibres, a first fibre for transporting signals output from the transceivers and a second fibre for transporting signals for input to the transceivers. This simplifies the optical interfacing and also provides a degree of redundancy should one or other fibre fail.

In embodiments where signals received at a cell are multiplexed onto the second fibre the cell signals may simply be transmitted onto the fibre, for example in the case of frequency or wavelength division multiplexing, or an optical signal may be received from the fibre and the cell's signal integrated with the received signal and the combined multiplexed signal then retransmitted onto the fibre (this latter approach may be used, for example with TDMA multiplexed cell signals).

In a preferred embodiment the fibre optic cable includes a cable loop and a switch to reverse the direction of signal transmission around the loop when a fault is detected or when system performance degrades. To increase the system's fault tolerance and to provide back up transmission paths should the fibre loop be accidentally severed. The reliance which many users place on mobile communications networks makes such a feature important in a practical embodiment.

The integrity of the cable loop may be monitored either where the Base Station Transceivers are located or, more preferably, a distributed monitoring system may be employed in which each cell includes a fibre monitor and means for transmitting a monitoring signal back to fibre optic drivers for the loop which may conveniently be co-located with the base station equipment. The signal monitor may be coupled to the multiplexed signal receiver and/or the cell signal transmitter at each cell or it may be separately coupled to the fibre optic cable. An rf telemetry transmitter, together with a corresponding receiver coupled to the fibre optic drivers may be used for signal transmission or the signal transmitter may employ a back channel (if necessary, multiplexed) on the fibre optic cable, for example, using a different wavelength or a different fibre or a different direction of signal transmission to distinguish the monitoring signal from the multiplexed traffic signals.

Use of a distributed monitoring system provides increased robustness and greater reliability as well as the potential for more accurately locating a fault. Such a monitoring system can also be used to provide remote alarm and network programming and diagnosis functions for equipment located at a cell and/or equipment located with the base stations.

Preferably the signal distribution system includes a signal combiner for combining the outputs of at least two of the rf transmitters before the combined outputs are multiplexed onto the signal transporter. This allows the signals from the transmitters of two or more different network operators to be combined, although the transmitters themselves may be coupled to different Base Station Controllers/Radio Network Controllers. Since the signal multiplexing is done on a per cell basis, when demultiplexed the combined signal will be processed by a single cell. At that cell the combined signal may be separated out into separate signals for the two (or more) network operators, for example by using filters where the two network operators have been allocated different transmit frequency bands, or the combined signal may be transmitted without separation.

In embodiments where the combined signal is transmitted from a cell or sector without separation into components from the different network operators, approximately the same coverage will be provided to the two or more network operators. Alternatively, the signals of the two or more operators may be separated before transmission to provide different, albeit possibly overlapping cell or sector coverage. Such a signal combiner may also be used where the system is distributing the network traffic of a single operator, for example, to provide redundancy by the provision of more than one transmitter per cell or sector, and/or to provide additional channels and traffic capacity for a cell or sector.

In a preferred embodiment, the system is used with cellular network transceivers, in which case a received signal from a selected cell may be split so that the received signal may be fed to inputs of two or more transceivers serving the cell or sector. In a simple embodiment a received signal line is merely connected in parallel to two transceiver inputs. However, practical embodiments preferably incorporate some form of buffering and/or impedance matching, as is well known to those skilled in the art. In other embodiments, the received signals may be processed with an additional layer of multiplexing and then demultiplexed before being input to the transceivers. Where both a signal combiner and a signal splitter is present, a single device with bi-directional input/output lines may be used to provide the combiner/splitter function. Alternatively, such a single combiner/splitter may be provided with separate input and output lines (a plurality of inputs and a single output for signal combination and a single input and a plurality of outputs for signal splitting) for ease of signal management.

In one embodiment of the signal distribution/signal reception system the network cells or sectors served by the system may comprise the cells or sectors of a single mobile communications network operator and in this case the transceivers comprise elements of that single operator's network. In other embodiments the network cells or sectors served by the system or systems comprise cells or sectors of more than one mobile communications network operator, that is, the transceivers are coupled to the networks of different operators although the geographical cell or sector sites served by the operators substantially correspond or overlap. The provision of a multi-operator system further reduces the number of cell or sector antenna/base station sites and this can further enhance the above described advantages of the systems.

In another aspect the invention provides a system for distributing signals from an rf transmitter to a plurality of antennas for transmitting to a plurality of coverage regions, the system comprising: an rf-to-optical converter for converting an rf input signal from the transmitter into an optical output signal; a fibre optic cable, coupled to the rf-to-optical converter, for transporting the optical signal; and a plurality of optical-to-rf converters, each coupled to the fibre optic cable, for providing an rf output signal corresponding to the rf signal from the transmitter to the plurality of antennas.

According to a further aspect of the invention there is provided a method of distributing signals for a communications network, the communications network having a plurality of cells or sectors each served by a transmitter, the method comprising multiplexing output signals from the transmitters to provide a composite signal comprising transmissions for each of the plurality of cells or sectors; distributing the composite signal to each of the cells or sectors; and selecting, at a said cell or sector, the transmission for the cell or sector from the composite signal.

According to another further aspect of the invention there is provided a complementary method of receiving signals for a communications network, the communications network having a plurality of cells or sectors each served by a receiver, the method comprising receiving signals from communications devices in the plurality of cells or sectors; forming a multiplexed signal comprising the signals received in the cells or sectors; transmitting the multiplexed signal to a demultiplexer; demultiplexing the received signals using the demultiplexer; and providing the or each receiver with a received signal from each said cell or sector. As described above, with reference to the signal reception system, one or a plurality of receivers may be used to serve the plurality of cells or sectors.

According to a still further aspect the invention provides a method of distributing an rf transmitter signal to cells or sectors of a wireless communications network, the method comprising: converting the rf transmitter signal to an optical signal; distributing the optical signal to the cells or sectors of the network over a fibre optical cable; and converting the optical signal to an rf signal for transmission at each said cell or sector.

These methods broadly correspond to the above described signal distribution and signal reception systems and provide corresponding advantages.

In a further aspect the invention provides a multiplexer for multiplexing rf output signals from a plurality of transmitters onto a multiplexed output signal, each transmitter serving at least one cell or sector in a cellular communication network, the multiplexer comprising a plurality of rf-to-optical converters to convert the rf outputs of the plurality of transmitters to a corresponding plurality of optical signals; and an optical multiplexer to multiplex the plurality of optical signals to provide a multiplexed optical output signal from which a signal for serving a cell or sector is selectable.

The multiplexer operates to multiplex a plurality of rf output signals from rf transmitters or transceivers on a cell-by-cell and/or sector-by-sector basis and thus provides base station equipment for distributing signals for a plurality of cells or sectors from a single physical location. The multiplexer is usable with either or both of the signal distribution system and signal reception system described above.

Preferably the multiplexer also includes at least one rf signal combiner for combining the rf outputs of transmitters serving substantially the same physical or geographical cell or sector, or for combining the outputs of transmitters serving overlapping cells or sectors. This allows a single set of physical or geographical cells or sectors to be served by more than one operator whilst at least partly using the same signal transmission equipment. The transmitters (or transceivers) for different network operators will generally be logically coupled to different controllers. It is thus further preferable to provide a common physical interface to a data transmission network for the transmitters (or transceivers) to further simplify physical network equipment installation.

In a further aspect the invention provides a demultiplexer for receiving and demultiplexing a multiplexed optical signal, the multiplexed signal comprising signals received from a plurality of cells or sectors of a cellular communications network, the demultiplexer comprising an optical demultiplexer to demultiplex the multiplexed optical signal into a plurality of separate optical signals, each corresponding to a signal received from a said cell or sector; and a plurality of optical-to-rf converters, each coupled to the optical demultiplexer, for converting the plurality of optical signals to a corresponding plurality of rf signals for output to a plurality of rf receivers serving the said plurality of cells or sectors.

The demultiplexer operates to demultiplex signals received at cells from mobile devices, on a cell-by-cell and/or sector-by-sector basis. Preferably, the demultiplexer also incorporates a signal splitter to receive a demultiplexed signal and split the signal into a plurality of versions for input to a corresponding plurality of receivers (or transceivers). This allows an individual cell or sector to be served by the receivers (or transceivers) of more than one operator or, when the demultiplexer is being used with base station equipment of only a single network operator, it facilitates the provision of additional capacity, by means of additional receivers (or transceivers) for the cell or sector.

The invention also provides a signal receiver for a cell or sector of a cellular communications network, the signal receiver comprising an optical input, to receive a multiplexed optical signal; an optical selector to select a part of the multiplexed optical signal comprising an optical signal carrying information for an rf signal for the cell or sector; and an optical-to-rf converter, having an input coupled to the optical selector and an output for receiving and converting the selected part of the multiplexed signal into an rf signal, and for outputting the rf signal for transmission by the cell or sector.

This receiver is operable with the above described multiplexer to select transmitter (or transceiver) signals for a cell or sector and to provide the selected signals to a cell or sector antenna.

In a complementary aspect the invention provides a signal transmitter for a cell or sector of a cellular communications network, the signal transmitter comprising an rf input for inputting an rf signal received from a cell or sector antenna; an rf-to-optical converter, coupled to the rf input, for converting the rf input signal to an optical signal; and an optical multiplexer, coupled to the rf-to-optical converter, to multiplex to the optical signal into a multiplexed optical signal comprising optical signals provided from one or more other cells or sectors.

The signal transmitter is usable to multiplex signals received at a cell or sector from a mobile communications device onto a signal transporter. As described above, a signal corresponding to the received signal can be multiplexed onto a fibre optic cable either by receiving a signal from the cable, multiplexing the cell or sector signal with the signal on the cable and then re-transmitting the signal, or by identifying a time or frequency allocation for the cell or sector and transmitting during that time or on that frequency.

Preferably, the above described transmitter and/or receiver include an optical signal monitor either as part of the optical selector/multiplexer or as a separate element with a separate connection to a fibre optic or other signal transporter. The signal monitor can be used to identify faults in the signal transmission signal and to report these back to a system management device which can then take action to switch in an alternative, back up signal transmission system. In a preferred embodiment the signal transmitter and receiver share a common optical front end to reduce the number of optical components in the cell-end equipment. Each cell or sector in a network operating with the above described signal distribution and reception signals may be provided with this type of signal receiver and/or transmitter so that mutually compatible multiplexed cell signals and transmitter signals are carried on a fibre optic loop.

According to a yet further aspect of the invention there is provided a system for coupling cell transceivers of a cellular mobile communications network to respective cell antennas, the system comprising a plurality of said cell transceivers and cell antennas; a transceiver signal combiner/separator coupled to the plurality of transceivers and to a signal bearer to combine transceiver output signals from the transceivers for output onto the signal bearer and to separate combined transceiver input signals received from the bearer for input to the transceivers; a signal bearer coupled to the combiner/separator to carry the combined transceiver input and output signals between the transceivers and each cell; and a plurality of cell signal combiner/separators, each coupled to the signal bearer and to a said cell antenna, to combine a signal received at the cell antenna with other signals on the signal bearer received at other cell antennas to provide said combined transceiver input signals, and to separate a transmit signal for the cell antenna from said combined transceiver output signals.

According to another aspect of the invention there is provided a cellular communications sub-system comprising a plurality of transceivers each serving a respective cell, each cell having a cell antenna characterised in that the transceivers for a plurality of said cells are substantially co-located, and in that the system further comprises transceiver interface means to combine rf interfaces of a plurality of the transceivers into a combined signal interface; transport means to transport signals between the combined signal interface and two or more of said cells; and coupling means to selectively couple signals between said transport means and each said cell antenna.

The transport means preferably comprises optical signal transport means such as a fibre optic cable, in a preferred embodiment a cable or an existing domestic cable network such as a cable TV or similar network. However, it may also include other signal transport means such as a co-axial cable and/or microwave rf link. As described above, separate or combined cell transmit and receive antennas may be provided. The signal interface is preferably a bi-directional signal interface which operates to combine transceiver rf outputs and to split an rf input between inputs of the transceivers.

In a further aspect the invention provides a signal distribution system for distributing signals for a wireless communications network in which a geographical area covered by the network is divided into cells, the system comprising a first wireless transmitter to provide a first signal output for serving a first cell; a second wireless transmitter to provide a second signal output for serving a second cell; a multiplexer having inputs coupled to the first and second wireless transmitters to receive the first and second signal outputs from the transmitters and having an output, to multiplex the received transmitter outputs onto a multiplexed output signal; a signal transporter coupled to the multiplexer output to transport the multiplexed signal to first and second cell sites; and

a first signal selector at the first cell, coupled to the signal transporter to select a first signal from the multiplexed signal corresponding to the signal output from the first transmitter, for serving the first cell.

In a yet further aspect the invention provides a signal transmission system for transmitting signals between a plurality of transmitters and/or receivers and a corresponding plurality of antennas, each antenna serving a separate cell of a cellular communications system, the signal transmission system comprising a fibre optic cable for coupling the transmitters and/or receivers and corresponding antennas, characterised in that the fibre optic cable includes a loop; and in that the system further comprises a monitor to monitor integrity of signal transmission on the cable loop and a switch responsive to the monitor to reverse a direction of signal transmission on the cable loop and/or to select an end of the cable loop for reception of signals from a cell of the communication system in response to the monitor signalling that the integrity of signal transmission is or has been adversely affected, for example, where transmission quality or system performance is degraded.

In a further aspect the invention provides a signal distribution system for a GSM mobile communications network comprising a digital communications network, at least one Base Station Controller (BSC) and a plurality of Base Transceiver Stations (BTSs), each Base Transceiver Station having a digital interface coupled to the Base Station Controller via the digital communications network, characterised in that the system further comprises a common digital interface device to the digital communications network; and in that each of the Base Transceiver Stations is coupled to the common interface device to provide a shared digital connection for the Base Transceiver Stations to the Base Station Controller.

In a still further aspect the invention provides a signal distribution system for a IMT-2000 mobile communications network comprising a digital communications network, at least one Radio Network Controller (RNC) and a plurality of Node Bs, each Node B having a digital interface coupled to the Radio Network Controller via the digital communications network, characterised in that the system further comprises a common digital interface device to the digital communications network; and in that each of the Node Bs is coupled to the common interface device to provide a shared digital connection for the Node Bs to the Radio Network Controller.

In the above described aspects of the invention, to facilitate use of the invention with an existing cable TV network, in embodiments of the invention cable TV signals are carried in a first fibre optical transmission band and communications network signals are carried in a second fibre optic transmission band, separate from the first band.

### BRIEF DESCRIPTION OF THE DRAWINGS

These and other aspects of the invention will now be further described, by way of example only, with reference to the accompanying figures in which:

FIG. 1 shows an overview of a GSM mobile communications network;

FIG. 2 shows a prior art in-building signal distribution signal for a GSM network;

FIGS. 3a and b show, respectively, prior art equipment for siting a cell antenna remote from a transceiver or transceivers, and a simplified block diagram of a transmitter signal distribution system;

FIG. 4 shows a schematic diagram of part of a ring architecture cable TV network;

FIG. 5 shows a schematic diagram of a signal transmission system for cells of a third generation cellular communications network;

FIG. 6 shows a more detailed schematic diagram for the signal transmission system of FIG. 5;

FIG. 7 shows a schematic diagram of a cell signal multiplexing arrangement for the system of FIG. 6; and

FIG. 8 shows a schematic diagram of cell antenna-end equipment for the system of FIG. 6.

### DETAILED DESCRIPTION OF THE EMBODIMENTS

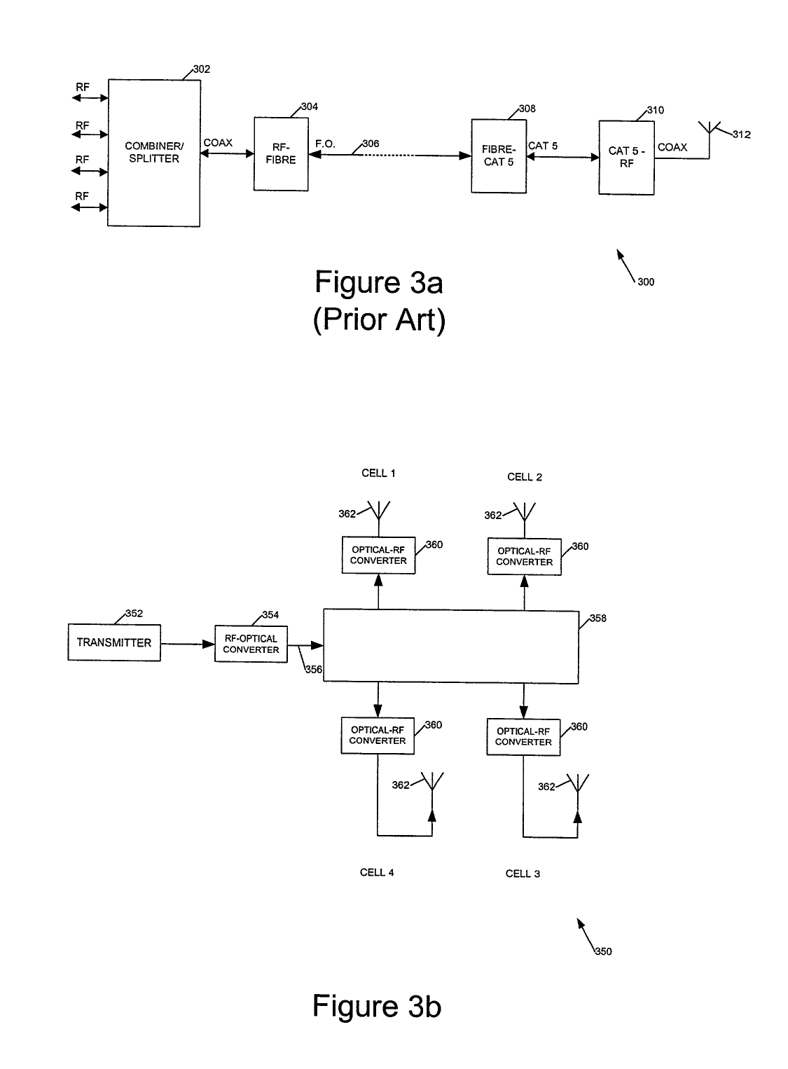

Referring first to FIG. 3b, this shows a simplified block diagram of a transmitter signal distribution system. In a third generation CDMA-based cellular mobile communications network adjacent cells or cell sectors may operate on the same transmit frequency since mobile communications devices within the cells identify transmissions using the spreading code sequence rather than (or in addition to) the broadband transmit frequency. Thus, in FIG. 3b, Cells 1 to 4 may all be served by a single transmitter, the need for separate cells arising in part because of the difficulties in providing coverage over a geographical area, particularly in urban environments where buildings cause shadowing and signals tend to propagate along the directions of streets. Thus the arrangement of FIG. 3b assists in achieving uniform coverage over an urban or suburban region and, in common with other aspects of the invention outlined above, also reduces the quantity of equipment required at each antenna site.

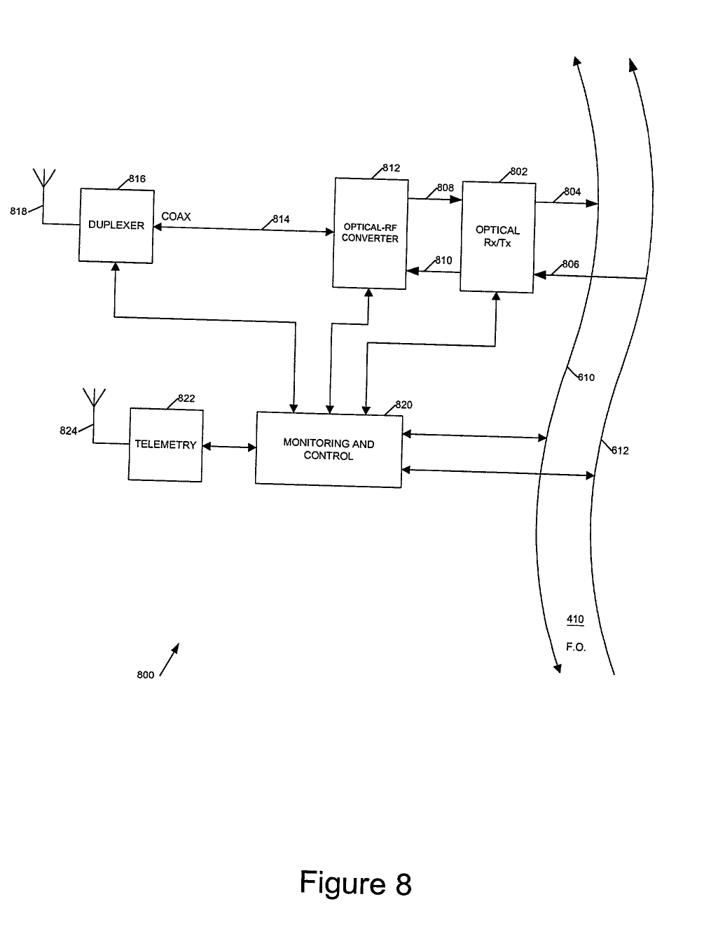

In FIG. 3b a transmit distribution system 350 comprises a transmitter 352 which may, for example, comprise one of a plurality of transmitters or transceivers in a BTS or Node B. Transmitter 352 is coupled to an rf-to-optical converter 354 which provides an optical output 356 modulated by the rf signal from transmitter 352. Optical output 356 is carried on a fibre optic cable which may comprise one or more single fibre cores. In a preferred arrangement fibre optic output 356 is coupled to a fibre optic cable loop 358 for greater fault tolerance and system resilience. The optical signal output of converter 354 is provided to each cell on spurs coupled to fibre optic loop 358 which provide the optical signal to an optical-to-rf converter 360 which, in turn, provides an rf output to an antenna 362. The arrangement of FIG. 3b is simplified and, in practice, each cell would normally be provided with further equipment such as, for example, that described below with reference to FIG. 8. As illustrated, the system employs a single transmitter 352 which, depending upon traffic and noise levels, might provide in the region of 50 CDMA channels. For larger scale systems a plurality of transmitters 352 may be employed, for example, between ten and twenty transmitters when serving forty to fifty cells or cell sectors.

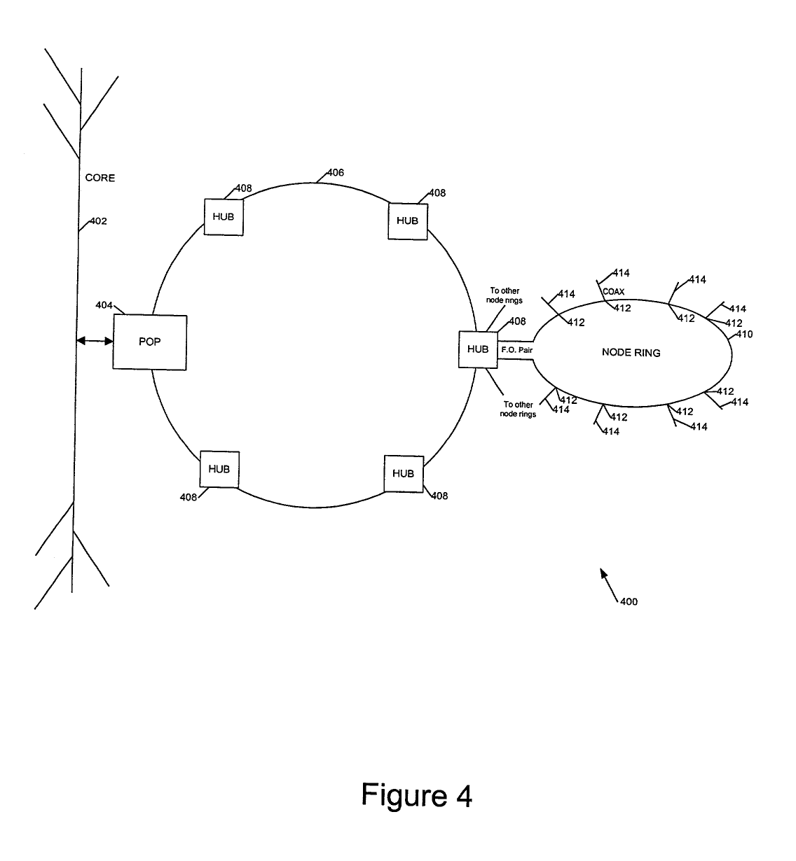

Referring now to FIG. 4, this shows part of a large area fibre optic communications network 400 for delivering cable TV signals to domestic homes. In FIG. 4 a network core 402 comprises a resilient STM-16/64 data transportation system operating at 155 Mbps or faster (where STM comprises 155 Mbps data channel and STM-64 comprises 64 such channels).

The network core 402 is coupled to a plurality point of presence 404 comprising a plurality of routers (of which only one is shown in FIG. 4) and/or switches (depending upon the network implementation) each serving a fibre optic ring 406 for a franchise area. Each franchise area ring 406 is coupled to a plurality of hubs 408 and to each hub is coupled a plurality of node rings 410. For clarity only a single node ring 410 is shown in FIG. 4. On each node ring is a plurality of node points 412 at which the “last mile” connection to a domestic homes is made.

The franchise area ring 406 and node ring 410 are constructed using fibre optic cable, and both typically comprise many fibre cores. As described in more detail below, a pair of fibre cores of the node ring 410 is used for cellular network signal transmission. The “last mile” connection 414 is made using co-axial cable and rf-fibre conversion equipment, for example including a bi-directional amplifier, is provided at each node point.

A “last mile” connection typically serves 500 homes; a node ring, 4,000 homes; a hub approximately 40,000 homes; and a franchise area typically comprises around 250,000 homes. A node ring is typically between 1 and 50 km in length. Although, for simplicity, node ring 410 is shown as a simple loop it may, in practice, have a more complex tree-and-loop structure. The franchise area ring 406 typically offers up to n×STM-1 whilst a node ring typically operates at 1×STM-1 (155 Mbps) per fibre.

The cable TV signals are transmitted digitally over the franchise area network and converted to rf at node points 412 for analogue delivery over co-axial cable for the last mile connection, although digital TV signals may also be transmitted directly to the home over co-axial cable links 414 or, in other TV delivery networks, over fibre to the home. Analogue rf over fibre signal transmission may also be used.

The applicant has recognised that such a cable TV delivery system can be used to provide environmentally sensitive cell coverage for 2G, 2.5G and 3G cellular communications networks, particularly in dense urban and suburban areas. Broadly speaking, the applicant has recognised that operator base station equipment can be located at or nearby hubs 408 and that the node rings 410 can then be used to transport signals for the cellular communications network between the base station equipment and remote cell site antennas. The cell site antennas are conveniently located at fibre node points 412 together with cell antenna-end equipment for transmitting signals from and to the antennas over the node ring.

Experimental studies have determined that in many areas satisfactory coverage for 3G cells can be provided using antennas at between 2 and 4 node points per ring. More node points may, however, be necessary in particularly dense urban environments where a cell's coverage area may be less than 350 meters across. The precise location of cell site antennas is determined in a similar way to the siting of conventional base stations, for example using cellular network planning tools. Although, for convenience, cell antennas are preferably located in the vicinity of fibre node points cell antenna-end equipment may also be coupled to the node rings at other points, for example, at specially created spurs.

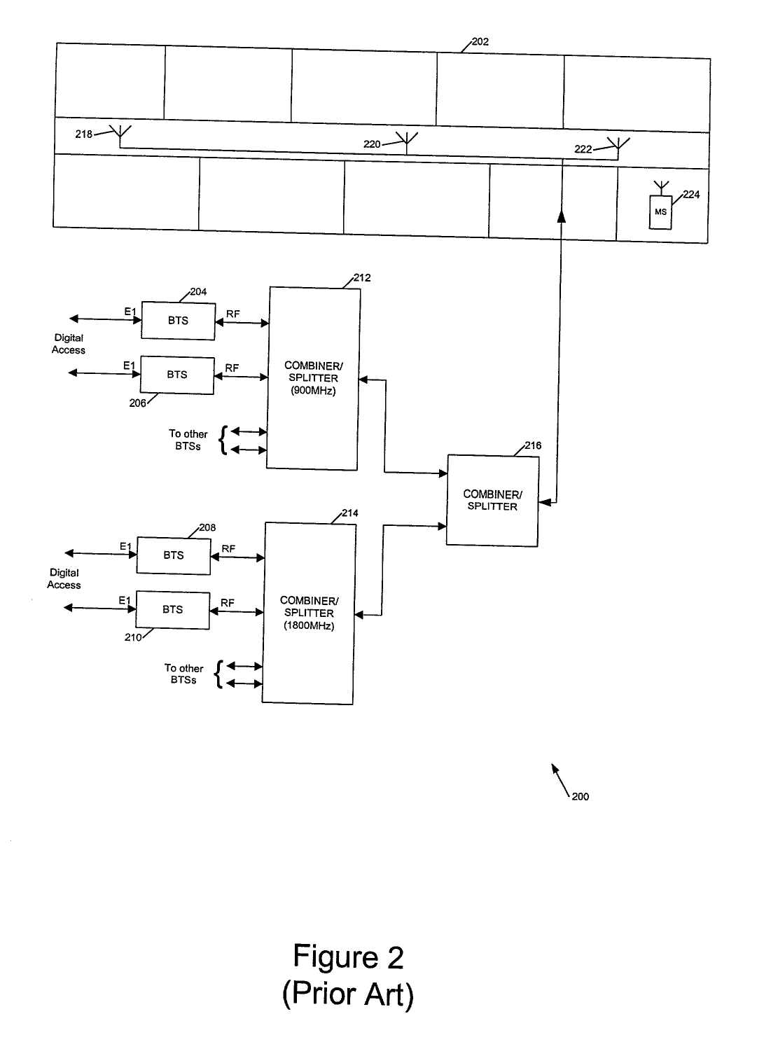

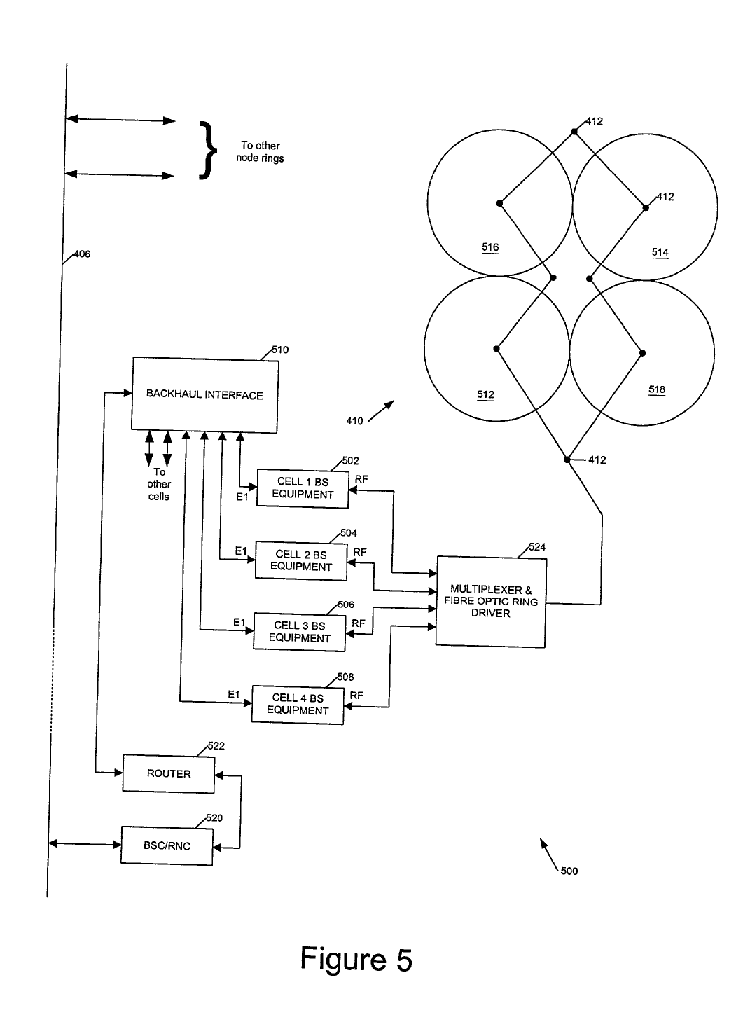

Referring now to FIG. 5, this shows a schematic diagram 500 of a system for transmitting signals from a base station or base stations to remote cell sites. In FIG. 5, Base Transceiver Station (BTS) or Node B equipment for serving four cells is schematically illustrated by blocks 502, 504, 506 and 508, serving respective mobile communications network cells 512, 514, 516 and 518. Cell base station equipment 502 to 508 is located at or nearby a hub 408 of FIG. 4 in a “BTS/Node B Hotel”. However, the BTS/Node B Hotel may be expanded to form a “super hotel” and located at point of presence 404. Although cells 512 to 518 are illustrated as providing outdoor coverage, one or more of the cells may provide in-building coverage and/or picocell coverage in a manner similar to that illustrated in FIG. 2.

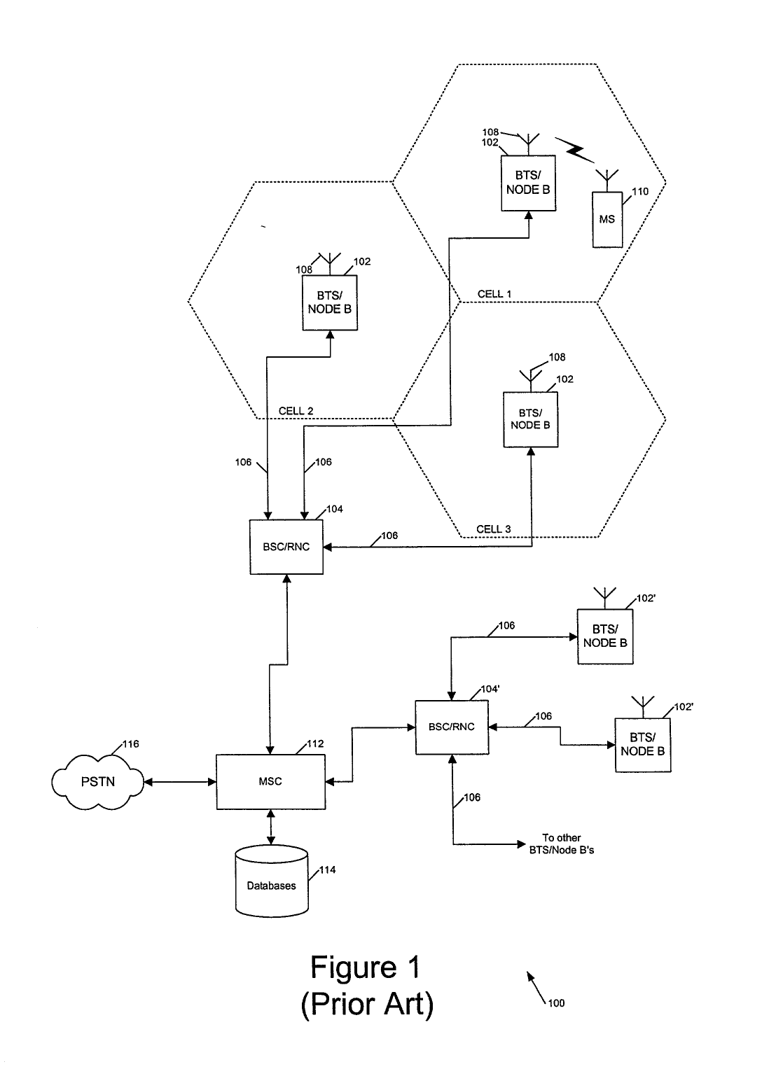

Cell base station equipment units 502 to 508 each have a digital E1 interface to a common backhaul interface 510 and via a router 522 and BSC/RNC 520, to franchise area ring 406, and eventually to core 402. Each BTS/Node B has a corresponding Base Station Controller (BSC) or Radio Network Controller (RNC) 520 although, as described with reference to FIG. 1, a single BSC/RNC normally serves a number of BTS/Node B's. In FIG. 5, a single BSC/RNC 520 is shown coupled to the backhaul network (although in some networks a switch may be used) but generally speaking a plurality of BSCs/RNCs will be required.

The backhaul network comprising franchise area ring 406 and/or core 402 logically operates as a direct wired connection between a BTS/Node B and its corresponding BSC/RNC. However, in other embodiments a “super BTS/Node B Hotel” may be created at which both BTSs/Node Bs and BSCs/RNCs are co-located. In such an arrangement a direct wired connection may be made between a BTS/Node B and its BSC/RNC and the BSC/RNC is then connected to the backhaul network as described above. In this way, traffic involving calls between BTSs or Node Bs attached to the same BSC/RNC need not be routed over the backhaul network, thus reducing network traffic and increasing connectivity and response speed. Such an arrangement is preferably employed where a relatively large number of BTSs or Node Bs is located at a hub 408.

The cell base station equipment units 502 to 508 each have an rf input/output interface to the BTS/Node B transceiver which is coupled to a multiplexer and fibre optic ring driver 524. The multiplexer and ring driver 524 accepts rf outputs from units 502 to 508 and multiplexes these, driving fibre optic ring 410 with the multiplexed signal. The multiplexed signal is provided to each of cells 512 to 518 by node ring 410 and each cell selects that part of the multiplexed signal intended for the cell and uses this to feed the cell's antenna. Likewise each cell also incorporates means for multiplexing a signal received at the cell from a mobile communications device onto fibre optic node ring 410 for reception by multiplexer and ring driver 524. These received signals are demultiplexed to provide separate received signals for each cell and the separate signals are then fed to rf inputs of cell base station equipment units 502 to 508 for reception by the BTS/Node B serving the respective cells.

The rf signals from and to each cell may be multiplexed in the analogue or digital domain. Thus, for example, the rf outputs of each cell unit 502 to 508 may be digitised (sampling at 4-5 GHz to meet the Nyquist criterion) and digitally combined, for example, on a packet-by-packet or bit-by-bit basis, into a digital signal having a bit rate substantially proportional to the number of cells. Likewise in such a system equipment at the cell antenna end digitises if signals received from mobile devices within the cell and digitally multiplexes this signal with corresponding digitised received signals from other cells circulating on fibre optic node ring 410. Such multiplexing may be achieved using fast TDMA techniques.

In another arrangement, the rf outputs from and inputs to the BTS/Node B transceivers may be shifted in frequency by, for example, analogue mixing of the rf signals with local oscillator signals. Thus, for example, signals for cell unit 502 may be mixed up to, for example, 20 GHz, signals for cell unit 504 up to 22 GHz, signals for cell unit 506 up to 24 GHz, and signals for cell unit 508 up to 26 GHz. These rf signals may then be combined and used to modulate optical carriers on node ring 410 for transporting signals to and from cells 512 to 518.

In a preferred embodiment, however, the rf signals from and to each cell unit 502 to 508 and from and to cell antenna-end equipment for each cell 512 to 518 are converted to optical signals at different wavelengths for transmission onto and reception from node ring 410. A different wavelength or “colour” is used for each cell, facilitating optical multiplexing and demultiplexing of the cell signals at the BTS/Node B Hotel or hub end and at the cell antenna end.

Any conventional fibre optic transmission band may be used, such as the ITU C-band (1530 nm-1565 nm), L-band (>1565 nm), or S-band (<1 1490 nm), or wavelengths in the 1310 nm region as used for wavelength division multiplexed (WDM) metropolitan area networks. Preferably the optical signals are all in the region of 1550 nm, the most commonly used fibre optic transmission window, although other wavelengths, such as 1310 nm, may also be employed depending, in part, upon the type of fibre optic cable installed. Since, in a preferred embodiment, the signal distribution system operates over a network which is also in use for delivery of cable TV signals the precise wavelengths of operation of the system for each cell should be selected so as not to interfere with existing cable TV data transmission signals. In practice, this does not present any significant problems since the 1550 nm wavelength band provides sufficient capacity for a large number of high bandwidth signals to be transmitted at different wavelengths.

In one embodiment the system uses dense wavelength division multiplexing (DWDM) to multiplex the signals from and to cell units 502 to 508 onto fibre optic node ring 410. A plurality of such DWDM signals may be employed, at least one per cell and preferably two per cell, one for an up link, the other for a downlink. In other embodiments coarse WDM may be employed.

As explained above, the IMT-2000 standard for 3G cellular communication networks in Europe and Japan employs two 5 MHz WCDMA spectral bands per network traffic channel, one for an uplink to a base station, the other for a downlink to a mobile station. Thus, in a preferred embodiment, when optical wavelength division multiplexing is employed a separate wavelength is employed for the uplink and for the downlink and one of these wavelengths is modulated by the 5 MHz WCDMA spectrum for the up link and the other is modulated by the carrier for the downlink. This simplifies interfacing with fibre optic node ring 410 since the uplink and down link signals can be readily separated, which is advantageous as these signals are propagating in different directions (i.e. from and to the cells) and, in a preferred embodiment as described below, on separate fibres. The choice of two separate wavelengths for the uplink and downlink logically corresponds to the frequency division duplex arrangement specified for 3G networks.

In the US a multi-carrier FDD rather than direct spread FDD arrangement is used, but the same principles broadly apply. In China, where time division duplexing is employed, the up and downlink signals may be separated by reference to TDD time frames and then transmitted over the fibre on separate wavelengths, or a single wavelength may be employed for the TDD signal.

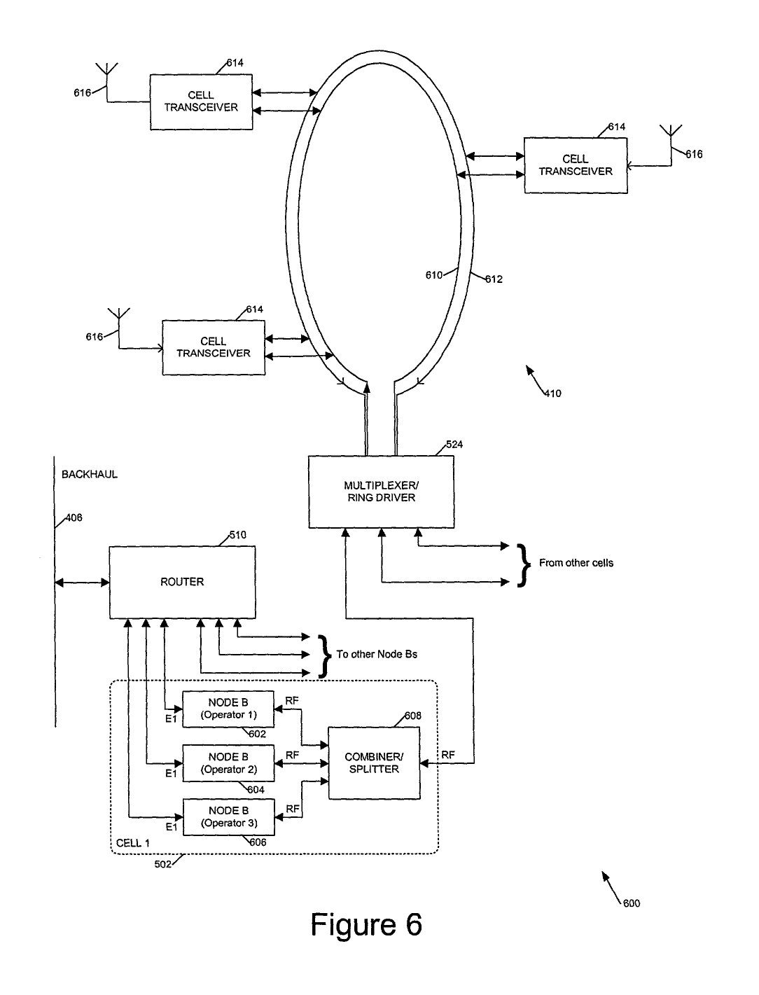

Referring now to FIG. 6, this shows a more detailed schematic diagram 600 for the signal transmission system of FIG. 5. In FIGS. 5 and 6, like elements are denoted by corresponding reference numerals. Cell base station equipment unit 502 is coupled to backhaul network 406 by, in this embodiment, a router 510. The cell equipment 502 is shown in more detail as comprising three Node B units 602, 604, and 606 each having an rf input/output interface coupled to an rf combiner/splitter 608.

The combiner/splitter 608 combines the rf outputs of the three Node B transceivers 602, 604, and 606, for example by means of a summing amplifier, and provides a combined rf output. The device also accepts an rf input and splits or divides or copies this into three signals for the rf inputs of the three Node B transceivers. The signal combiner and splitter functions may be combined in a single piece of equipment, either by means of separate inputs and outputs for the combiner and splitter or by, for example, using rf duplexers on the three rf lines to the Node B transceivers and on the single combiner/splitter rf “output” interface line to the multiplexer and fibre optic ring driver 524, in a conventional manner. The rf combiner/splitter 608 is coupled to multiplexer and fibre optic ring driver 524. Likewise, cell units 504 to 508, not shown in FIG. 6, are also coupled to multiplexer ring driver 524.

As illustrated in FIG. 6, node ring 514 comprises a pair of optical fibres 610, 612 carrying counter-propagating optical signals around the fibre optic loop, although a single fibre can also be used. This allows signals from the cells to be carried on a first of the optical fibres, fibre 612, and signals to the cells to be carried on a second optical fibre, fibre 612. This simplifies interfacing to the signal transmission system at the cell and ring driver ends.

Since the signals from and to the cells are separated onto separate optical fibres in other embodiments signals from the cells propagate in both directions around loop 410 on fibre 612. This provides redundant signal paths and allows multiplexer/ring driver 524 to receive signals from all the cells even if fibre loop 612 is broken. Likewise it is preferable that multiplexer/ring driver 524 is capable of driving optical signals in either direction around fibre loop 610, for example by means of an optical changeover switch, so that signals can be provided to all the cells even when fibre loop 610 is broken. For example, if fibre loop 610 is broken at the top in FIG. 6, signals may be transmitted from multiplexer/ring driver 524 to the cells on the two separate remaining portions of optical fibre 610.

The signal distribution system includes a plurality of cell transceivers 614 coupled to fibre node ring 410, preferably at node points 412. A cell transceiver is provided for each cell of the mobile communications network or networks served by the system, such as cells 512 to 518 of FIG. 5. It will be appreciated, however, that since in a CDMA system adjacent cells may share transmit frequencies, a single transceiver may provide transmit signals for more than one cell.

A cell transceiver 614 receives a multiplexed optical signal from multiplexer/ring driver 524 which includes an optical signal carrying information for an rf signal to be transmitted from the cell. The cell transceiver 614 selects a transmitter signal intended for transmission from its cell and outputs a corresponding rf transmission from an antenna 616 to which it is coupled for transmitting traffic and other data to mobile devices within the cell.

Cell antenna 616 also receives rf signals from mobile communications devices within the cell and cell transceiver 614 outputs these signals onto fibre optic node ring 410, multiplexed with signals received at other cells from other mobile devices. Multiplexer/ring driver 524 then demultiplexes the multiplexed signals received by cells from mobile devices and provides these demultiplexed signals to corresponding base transceiver stations or Node Bs serving the cells. The skilled person will appreciate that separate or combined antennas may be used for cell transceiver antenna 616.

As illustrated in FIG. 6, cell unit 502 may comprise Node Bs (or BTSs) for more than one cellular communications network operator. Where this is the case, the signals from the transceivers of the different operators are combined in combiner/splitter 608 as described above and the combined signal is provided as a signal for a cell transceiver 614 on node ring 410. The cell transceiver 614 receives the combined signal from the different operators and transmits the combined rf signal from antenna 616, thus providing transmissions from a plurality of different operators simultaneously using a single signal transmission system.

Similarly, antenna 616 and cell transceiver 614 receive signals from mobile communications devices using different operators' networks and multiplex the combined received signals onto node ring 410. As described above, multiplexer/ring driver 524 then demultiplexes the combined signals for a cell and feeds these to combiner/splitter 608 for distribution to the transceivers 602 to 606 of the different operators. When used in this way, combiner/splitter 608 may simply provide the combined rf signal received at a cell to all the transceivers or the splitter may divide the combined signal up into separate signals for each transceiver.

In one embodiment such a division may be based upon frequency. For example, in the UK, three of the five licensed operators has been allocated two separate 5 MHz up link and downlink WCDMA FDD frequency bands. Thus, combiner/splitter 608 may employ a first filter to filter the combined received rf signals to provide a filtered output comprising substantially only those signals in a frequency band allocated to a first operator, and may include similar second and third filters for filtering signals for second and third operators, to provide filtered signals to the three transceivers 602 to 606 of the three different operators.

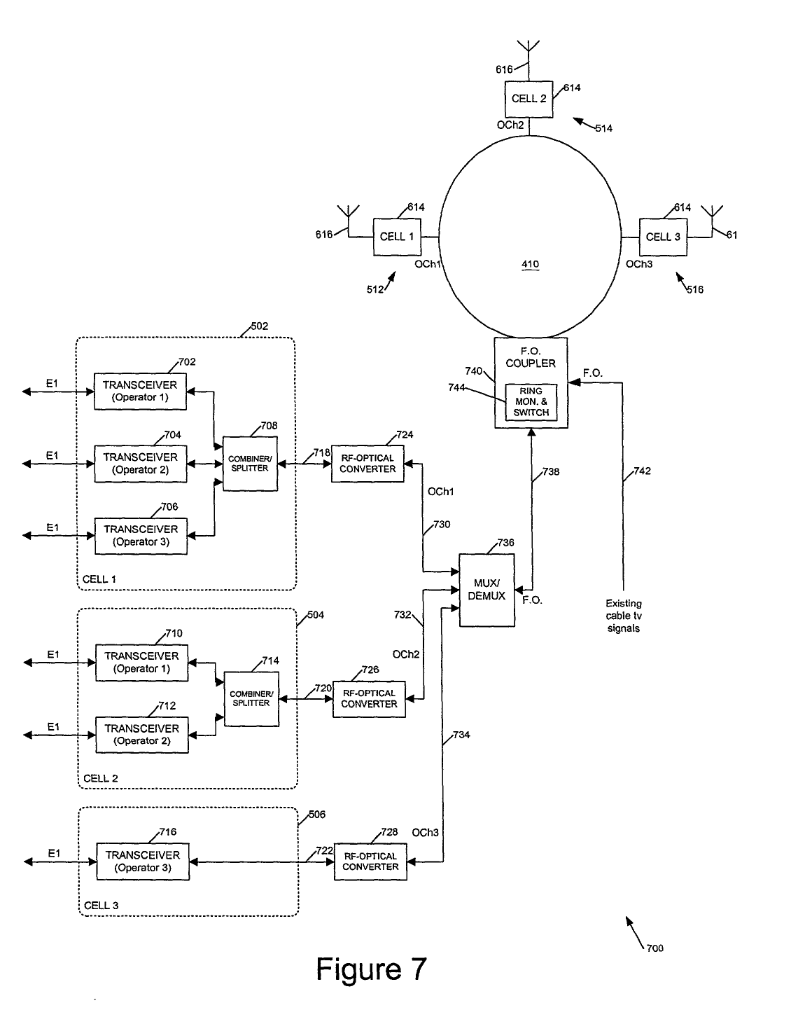

Referring now to FIG. 7, this shows a more detailed schematic diagram of a cell signal multiplexing/demultiplexing system 700 for use with the arrangement of FIG. 6. In FIG. 7, three cell equipment units 502, 504 and 506 are shown, each comprising transceivers for a different respective cell, cells 512, 514 and 516 on node ring 410.

Cell unit 502 comprises three transceivers 702, 704 and 706, corresponding to Node Bs 602, 604 and 606 of FIG. 6, for three different network operators. Radio frequency signals to and from these transceivers are coupled to rf combiner/splitter 708, corresponding to combiner/splitter 608 of FIG. 6. In a similar manner, transceivers 710 and 712 of cell unit 504 are coupled to rf combiner/splitter 714. Cell unit 506 comprises only one transceiver, transceiver 716. As illustrated, cell one is served by three operators, operators 1, 2 and 3; cell two is served only by operators 1 and 2, whilst cell three is served only by network operator 3. Each of transceivers 702, 704, 706, 710, 712, 716 has a digital E1 or optical interface for coupling the transceiver to a backhaul network, not shown in FIG. 7.

In third generation and other CDMA-based cellular communications networks the CDMA access allows a single operator to use the same frequency bands in adjacent or even overlapping cells. Thus in FIG. 7 the frequency bands in which the transceivers 702 and 710 of operator 1 operate may be the same and, similarly, transceivers 706 and 716 of operator 3 may also work within the single 2×5 MHz frequency band allocated to operator 3.

Each cell unit 502, 504 and 506 has a corresponding rf input/output line 718, 720 and 722 to couple the cell to a respective rf-optical converter 724, 726 and 728. The rf-optical converters convert an rf input signal to an optical output signal and an optical input signal to an rf output signal (although only one input and one output line are shown in FIG. 7).

The optical input/output 730 of converter 724 is on a first optical channel comprising a first pair of optical wavelengths; the optical input output 732 of converter 726 is on a second optical channel comprising a second pair of optical wavelengths, different to the first pair; and the optical input output 734 of converter 728 is on a third optical channel comprising a third pair of wavelengths different to the wavelengths used for the first and second optical channels. Each of three optical input/outputs 730, 732 and 734 is coupled to an optical multiplexer/demultiplexer 736 which combines optical inputs on lines 730, 732 and 734 and provides a wavelength division multiplexed (WDM) output on optical fibre 738, and demultiplexes a WDM signal on line 738 providing demultiplexed optical outputs on lines 730, 732 and 734. As can be seen from the foregoing description, in this embodiment each cell is assigned a separate optical channel comprising a pair of wavelengths corresponding to the radio frequency up link and downlink channels for the cell.

The input/output line 738 of multiplexer/demultiplexer 736 is coupled to a fibre optic coupler 740 which is coupled to node ring 410 and which drives optical input signals on line 738 around node ring 410 and which provides optical signals received from node ring 410 as an optical output on line 738 to the multiplexer/demultiplexer 736.

Fibre optic coupler 740 also receives an input on line 742 comprising an optical signal carrying legacy cable TV signals on a different wavelength to those allocated to the optical channels serving the cellular network cells. In a particularly preferred embodiment it has experimentally been found possible to use wavelengths in the 1550 nm optical band to carry cellular communication network signals at the same time as cable TV signals are distributed using a lower wavelength transmission window, for example, at 1310 nm.

Preferably, fibre optic coupler 740 includes drive circuitry for transmitting signals over >1 km, more preferably >10 km, and most preferably >20 km to the remote cell antenna sites, although in dense urban areas shorter transmission distances may be sufficient. Likewise fibre optic coupler 740 should be capable of receiving signals transmitted over corresponding distances from the cells.

The rf-optical converters 724, 726 and 728, multiplexer/demultiplexer 736 and fibre optical coupler 740 together comprise elements of the multiplexer and ring driver 524 illustrated in FIG. 5. The cells 512, 514 and 516, cell transceivers and antennas 614 and 616, and node ring 410 correspond to the like elements illustrated in FIGS. 4, 5 and 6.

The fibre optic coupler 740 also includes a fibre optic node ring monitor and switch 744 to monitor node ring 410 for faults and to switch the direction of signal transmissions around node ring loop 410 in response to detection of faults in the node ring fibre optic cable. Ring monitor and switch 744 is also configured to control fibre optic coupler 740 to receive inputs from either end of node ring 410 to provide a redundant circuit should a fault in the node ring prevent signal transmission from a cell from propagating around the loop in one direction.

Ring monitor/switch 744 may receive signals from the cells indicating faults and/or quality degradation and switch signal transmission/reception in response to these signals to provide fault tolerance or it may itself monitor node ring 410, for example by polling each cell transceiver in turn or by looking for lost carriers—that is, signals at particularly wave lengths which are no longer present because signals from the corresponding cell are no longer being received—or, other forms of monitoring such as optical prime domain reflectometry (OTDR) may be employed.

Now referring to FIG. 8, this shows a schematic diagram of an embodiment of a cell transceiver 800, similar to the cell transceiver 614 shown as forming part of the signal distribution system illustrated in FIG. 6.

The cell transceiver 800 comprises an optical receiver/transmitter 802 coupled to optical fibres 610 and 612 of node ring 410 by means of optical input 806 and optical output 804. Optical receiver/transmitter 802 receives an optical input 806 comprising optically multiplexed signals for a plurality of cells and selects from this input an optical signal carrying an rf signal for the cell in which the optical receiver/transmitter is installed. The signal so selected is provided at optical output 810. It will be understood that the optical receiver/transmitter 802 of each cell will be configured to select a part of the multiplexed optical signal on optical fibre 610 which is different to parts of signals selected by other cells.

When used with the system embodiment described above with reference to FIG. 7, the signal for a particular cell may be selected by appropriately selecting the wavelength corresponding to the downlink for the optical channel of that cell. This may be accomplished by, for example, using a narrow-band optical filter.

In a similar way, optical receiver/transmitter 802 receives an optical input 808 and provides an optical output 804 to optical fibre 612 of fibre optic node ring 410. The optical output 804 is multiplexed onto fibre 612 together with the optical outputs from other cells. In a preferred embodiment, this is done using wavelength division multiplexing as described above, each cell in effect, outputting signals onto optical fibre 612 at a cell-specific wavelength, for example by modulating an appropriately tuned narrow-band laser source. In alternative embodiments, other forms of multiplexing, such as TDMA, may be used, for example, by establishing a TDMA frame as a timing reference and providing burst transmissions from each cell timed so as not to overlap.

It will be apparent to the skilled person that node ring 410 need not employ two separate optical fibres 610 and 612 but could employ, for example, bi-directional signal transmission on a single optical fibre or TDMA-controlled signal reception and transmission.

Optical output 810 is coupled to optical-rf converter 812 which provides a corresponding rf output on rf input/output line 814 comprising an rf signal for transmission by the cell. Similarly, optical-rf converter 812 receives an rf input on line 814 and provides a corresponding optical output, modulated by the rf input, to optical input 808.

The rf input/output 814 of optical-rf converter 812 is coupled to rf duplexer 816 comprising, for example, a low-noise, medium power, bi-directional rf amplifier and appropriate filters, and/or a circulator. The duplexer 816 may be of a conventional type, as is well known to those skilled in the art. Duplexer 816 is coupled to receive/transmit antenna (or antenna array) 818, which again may be selected from conventional antenna types suitable for 2G/2.5G/3G cellular communications networks, as are again well known to those skilled in the art.

The link between converter 812 and duplexer 816 may comprise conventional co-axial cable for cable runs of up to, for example, 50-100 meters. For longer cable runs, optical-rf converter 812 may be located in the vicinity of antenna 818 and fibre optic cable used for a greater part of the cable run.

The skilled person will appreciate that antenna 818 need not be exactly co-located with cell transceiver 800, and that any suitable conventional means may be employed to couple antenna 818 to cell transceiver 800. This flexibility allows the use of a variety of antenna sites so that antennas may be mounted, for example, at street level or on lamp posts or other street furniture or on buildings and, optionally, disguised. Preferably, however, antenna 818 is mounted relative close to cell transceiver 800, which is facilitated in the presently described signal distribution system by the relatively small amount of equipment required at the cell-end.

Preferably cell transceiver 800 includes a transceiver monitoring and control device 820 coupled to duplexer 816, converter 812 and optical receiver/transmitter 802 to provide remote cell transceiver programming and diagnosis functions.

In a preferred embodiment, monitoring and control device 820 is also coupled to optical fibres 610 and 612 to monitor optical signals on the fibres to check for faults in node ring 410. In alternative embodiments, monitoring and control device 820 may monitor fibres 610 and 612 indirectly using monitoring signals provided by optical receiver/transmitter 802.

The lack of a signal on optical fibre 6 10 indicates a break in the fibre upstream of the cell towards the fibre optic ring driver whilst a missing signal from one or more cells upstream on fibre 612 indicates a break in fibre 612 and, by determining the last cell in an upstream direction from which a signal is present, allows an approximate location of the fault or break to be identified. Monitoring and control device 620 may then send a signal back to the fibre optic ring driver 524 to switch to an alternative transmission and/or reception pathway (since, in general, when this type of monitoring is being employed, signals transmitted from cells to the fibre optic ring driver are transmitted bi-directionally).

Monitoring and control device 820 may communicate with fibre optic ring driver 524 using a separate optical wavelength to provide a so-called “back channel” which is preferable for ease of installation of the cell transceiver. In other embodiments off-air monitoring may be employed. Additionally or alternatively the monitoring and control device may be coupled to a telemetry transmitter 822 and a telemetry antenna 824 for wireless telemetry communication with the fibre optic ring driver.

Signals transmitted by monitoring and control device 820 may include a simple warning signal that a fault has occurred but preferably incorporate more detailed diagnostic information to allow remedial action to be taken, either automatically by the signal distribution system or by, for example, physical repair of a faulty system component.

Many effective alternatives to the above described embodiments will no doubt occur to the skilled person. For example, although the invention has been described, with reference to FIG. 4, in the context of a node ring topology it is also applicable to other network topologies such as star, tree and branch and tree and bush topologies, as well as to hybrid topologies. Similarly, the invention is not limited to use with 2.5 or 3G mobile communications networks but can also be employed to distribute signals for, for example, narrowband PAMR (Public Access Mobile Radio) and PMR (Private Mobile Radio) networks such as Tetra, broadband Fixed Radio Access (FRA) and wireless local loop systems, and for the 5.7 GHz hyperLAN concept of a high data rate (10-100 Mbps) picocell-based wireless LAN.

It should be understood that the invention is not limited to the described embodiments but includes modifications within the spirit and scope of the present invention which will be apparent to the person skilled in the art.

1. A signal distribution system for distributing wireless communications network signals, the system comprising:
a plurality of rf transmitters for transmitting rf signals to serve communications devices in a plurality of network cells or sectors; and
characterised in that the system further comprises:
a multiplexer, coupled to the rf transmitters, for multiplexing output signals from the transmitters and outputting a multiplexed transmitter signal;
a signal transporter, coupled to the multiplexer, for transporting the multiplexed transmitter signals to each of the network cells or sectors served by the transmitters; and
a multiplexed signal receiver at each served cell or sector, coupled to the signal transporter, for selecting and receiving a transmitter signal from an rf transmitter serving the cell or sector from the multiplexed transmitter signal.

2. A signal distribution system as claimed in claim 1, further comprising a transmit antenna at each served cell or sector, coupled to an output of a respective multiplexed signal receiver, for transmitting a signal from the rf transmitter serving the cell or sector to a communications device within the cell or sector.

3. A signal distribution system as claimed in claim 2, further comprising at least one signal combiner having inputs coupled to at least two of the rf transmitters and an output coupled to the multiplexer, to combine the outputs of the rf transmitters and output a combined signal for multiplexing.

4. A signal distribution system as claimed in claim 3, wherein each transmitter is connected to a common digital interface to a digital data transmission network.

5. A signal distribution system as claimed in claim 1, further comprising:
a plurality of rf receivers, each associated with a said rf transmitter, for receiving rf signals from devices in the plurality of network cells or sectors;
a cell signal transmitter at each cell or sector, coupled to the signal transporter, for receiving a signal from a communications device in the cell or sector and for outputting a cell or sector signal onto the signal transporter to make up at least part of a multiplexed cell or sector signal; and
a demultiplexer, coupled to the signal transporter, for demultiplexing the multiplexed cell or sector signal and for outputting a plurality of demultiplexed cell or sector signals corresponding to the plurality of rf receivers.

6. A signal distribution system as claimed in claim 5, further comprising a receiver antenna at each said cell or sector, coupled to the respective cell or sector signal transmitter of the cell or sector.

7. A signal distribution system as claimed in claim 5 or 6, further comprising at least one signal splitter having an input coupled to the demultiplexer and outputs coupled to at least two of the rf receivers, to provide at least one said demultiplexed cell or sector signal to two or more of the rf receivers.

8. A signal distribution system as claimed in claim 7, comprising a plurality of rf transceivers, each comprising a said rf transmitter and rf receiver, each transceiver forming part of either a Base Transceiver Station (BTS) of a GSM network or a Node B of an IMT-2000 network.

9. A signal distribution system as claimed in claim 5, wherein the signal transporter comprises a fibre optic cable, the multiplexed transmitter signal comprises an optical signal and the multiplexed cell signal comprises an optical signal.

10. A signal distribution system as claimed in claim 9, wherein the fibre optic cable comprises a pair of optical fibres, a first fibre for transporting the multiplexed transmitter signal and a second fibre for transporting the multiplexed cell or sector signal.

11. A signal distribution system as claimed in claim 9, wherein the fibre optic cable forms part of a cable TV distribution system.

12. A signal reception system for receiving wireless communications network signals, the system comprising:
at least one rf receiver for receiving rf signals from communications devices in a corresponding plurality of network cells or sectors served by the receiver; and
characterised in that the system further comprises:
a signal transporter for transporting signals from each served cell or sector to a demultiplexer;
a cell or sector signal transmitter at each cell or sector, coupled to the signal transporter, for receiving a signal from a communications device in the cell or sector and for transmitting a cell or sector signal onto the signal transporter to make up at least part of a multiplexed cell or sector signal on the signal transporter; and
a demultiplexer, coupled to the signal transporter and to the rf receiver, for demultiplexing the multiplexed cell or sector signal on the signal transporter and for outputting a plurality of demultiplexed cell or sector signals to the receiver.

13. A signal reception system as claimed in claim 12, further comprising a receive antenna at each said cell or sector, coupled to the respective cell or sector signal transmitter of the cell or sector.

14. A signal reception system as claimed in claim 13, comprising a plurality of said rf receivers for receiving signals from the plurality of network cells or sectors, and wherein the demultiplexer outputs the plurality of demultiplexed signals to the plurality of receivers.

15. A signal reception system as claimed in claim 14, further comprising at least one signal splitter having an input coupled to the demultiplexer and outputs coupled to at least two of the rf receivers, to provide at least one said demultiplexed cell or sector signal to two or more of the rf receivers.

16. A signal reception system as claimed in claim 15, wherein each rf receiver is connected to a common digital interface to a digital data transmission network.

17. A signal reception system as claimed in claim 16, wherein the signal transporter comprises a fibre optic cable, and wherein the multiplexed cell or sector signal comprises an optical signal.

18. A signal reception system as claimed in claim 17, wherein the fibre optic cable forms part of a cable TV distribution system.

19. A signal distribution or reception system as claimed in claim 9 or 17, wherein the fibre optic cable includes a cable loop; the system further comprising a monitor to monitor integrity of signal transmission on the cable loop and a switch responsive to the monitor to reverse a direction of signal transmission on the cable loop in response to the monitor signalling that the integrity of signal transmission is or has been adversely affected.

20. A signal distribution system as claimed in claim 19, wherein a said monitor is located at a cell and the switch is located at a point on the cable loop remote from the monitor; the system further comprising a monitoring signal transmitter for transmitting a monitoring signal from the monitor to the switch.

21. A signal distribution system as claimed in claim 1 or 12, wherein the plurality of served network cells or sectors comprises cells or sectors of a single mobile communications network operator.

22. A signal distribution system as claimed in claim 1 or 12, wherein the plurality of served network cells or sectors comprises cells or sectors of a plurality of different mobile communications network operators.

23. A system for distributing signals from an rf transmitter to a plurality of antennas for transmitting to a plurality of coverage regions, the system comprising:
an rf-to-optical converter for converting an rf input signal from the transmitter into an optical output signal;
a fibre optic cable, coupled to the rf-to-optical converter, for transporting the optical signal; and
a plurality of optical-to-rf converters, each coupled to the fibre optic cable, for providing an rf output signal corresponding to the rf signal from the transmitter to the plurality of antennas.

24. A system as claimed in claim 23, wherein the fibre optical cable comprises a loop and wherein the optical-to-rf converters are coupled to the fibre optic cable at points within the loop.

25. A system as claimed in claim 24, for distributing signals of a cellular communications network, wherein the plurality of antennas serve a plurality of cells or sectors of the network and wherein the transmitter provides a common rf transmit signal for all the said cells or sectors.

26. A method of distributing signals for a communications network, the communications network having a plurality of cells or sectors each served by a transmitter, the method comprising:
multiplexing output signals from the transmitters to provide a composite signal comprising transmissions for each of the plurality of cells or sectors;
distributing the composite signal to each of the cells or sectors; and
selecting, at a said cell or sector, the transmission for the cell or sector from the composite signal.

27. A method of distributing signals as claimed in claim 26, further comprising:
monitoring a signal distribution path; and
switching to an alternate signal distribution path when the monitoring indicates failure or partial failure of the signal distribution path.

28. A method as claimed in claim 27, further comprising using a cable TV network to distribute the said composite signal.

29. A method of receiving signals for a communications network, the communications network having a plurality of cells or sectors each served by a receiver, the method comprising:
receiving signals from communications devices in the plurality of cells or sectors;
forming a multiplexed signal comprising the signals received in the cells or sectors;
transmitting the multiplexed signal to a demultiplexer;
demultiplexing the received signals using the demultiplexer; and
providing the or each receiver with a received signal from each said cell or sector.

30. A method of receiving signals as claimed in claim 29, further comprising monitoring a signal transmission path; and
switching to an alternate signal transmission path when the monitoring indicates failure or partial failure of the signal transmission path.

31. A method as claimed in claim 30, further comprising using a cable TV network to transmit the said multiplexed signal.

32. A method of distributing signals as claimed in claim 26 or a method of receiving signals as claimed in claim 29, wherein the distributed and/or received signals comprise signals for two or more communications networks having different operators.

33. A method of communicating signals for a communications network, the communications network having a plurality of cells or sectors each served by a transmitter and receiver, the method comprising:
multiplexing output signals from the transmitters to provide a composite signal comprising transmissions for each of the plurality of cells or sectors;
distributing the composite signal to each of the cells or sectors; and
selecting, at a said cell or sector, the transmission for the cell or sector from the composite signal; and
receiving signals from communications devices in the plurality of cells or sectors;
forming a multiplexed signal comprising the signals received in the cells or sectors;
transmitting the multiplexed signal to a demultiplexer;
demultiplexing the received signals using the demultiplexer; and
providing the or each receiver with a received signal from each said cell or sector; and
wherein said distributing and said transmitting use separate fibres of a single fibre optic cable.

34. A method of distributing an rf transmitter signal to cells or sectors of a wireless communications network, the method comprising:
converting the rf transmitter signal to an optical signal;
distributing the optical signal to the cells or sectors of the network over a fibre optical cable; and
converting the optical signal to an rf signal for transmission at each said cell or sector.

35. A multiplexer for multiplexing rf output signals from a plurality of transmitters onto a multiplexed output signal, each transmitter serving at least one cell or sector in a cellular communication network, the multiplexer comprising:
a plurality of rf-to-optical converters to convert the rf outputs of the plurality of transmitters to a corresponding plurality of optical signals; and
an optical multiplexer to multiplex the plurality of optical signals to provide a multiplexed optical output signal from which a signal for serving a cell or sector is selectable.

36. A multiplexer as claimed in claim 35, further comprising at least one rf signal combiner for combining rf outputs from a plurality of transmitters serving substantially the same geographical cell or sector, or overlapping cells or sectors, and wherein said rf-to-optical converter is coupled to an output of the rf signal combiner, to convert the combined rf outputs to an optical signal for said optical multiplexer, whereby a signal for serving a cell or sector comprising signals from a plurality of transmitters serving the cell or sector is selectable from the multiplexed optical signal.

37. A multiplexer as claimed in claim 36, further comprising a demultiplexer for receiving a multiplexed optical signal and for demultiplexing an optical signal for at least one said cell or sector from the received multiplexed signal.

38. A multiplexer as claimed in claim 37, further comprising an optical-to-rf converter to receive and convert the demultiplexed optical signal to an rf signal; and an rf splitter coupled to the optical-to-rf converter to provide the rf signal to two or more receivers serving the said cell or sector.

39. A demultiplexer for receiving and demultiplexing a multiplexed optical signal, the multiplexed signal comprising signals received from a plurality of cells or sectors of a cellular communications network, the demultiplexer comprising:
an optical demultiplexer to demultiplex the multiplexed optical signal into a plurality of separate optical signals, each corresponding to a signal received from a said cell or sector; and
a plurality of optical-to-rf converters, each coupled to the optical demultiplexer, for converting the plurality of optical signals to a corresponding plurality of rf signals for output to a plurality of rf receivers serving the said plurality of cells or sectors.

40. A demultiplexer as claimed in claim 39, further comprising at least one signal splitter having an input coupled to an output of a said optical-to-rf converter and a plurality of outputs, to output a corresponding plurality of versions of an rf signal input to the splitter for providing the rf output signal versions to a plurality of receivers serving substantially the same cell or sector or overlapping cells or sectors.

41. A signal receiver for a cell or sector of a cellular communications network, the signal receiver comprising:
an optical input, to receive a multiplexed optical signal;
an optical selector to select a part of the multiplexed optical signal comprising an optical signal carrying information for an rf signal for the cell or sector; and
an optical-to-rf converter, having an input coupled to the optical selector and an output for receiving and converting the selected part of the multiplexed signal into an rf signal, and for outputting the rf signal for transmission by the cell or sector.

42. A signal transmitter for a cell or sector of a cellular communications network, the signal transmitter comprising:
an rf input for inputting an rf signal received from a cell or sector antenna;
an rf-to-optical converter, coupled to the rf input, for converting the rf input signal to an optical signal; and
an optical multiplexer, coupled to the rf-to-optical converter, to multiplex to the optical signal into a multiplexed optical signal comprising optical signals provided from one or more other cells or sectors.

43. A signal receiver or transmitter as claimed in claim 41 or 42, further comprising an optical signal monitor having an optical input for monitoring an optical signal present at the signal receiver or transmitter; and
a signal transmitter, coupled to the optical signal monitor, for transmitting a system management signal to indicate that a level of the monitored optical signal has dropped below a threshold value.

44. A system for coupling cell transceivers of a cellular mobile communications network to respective cell antennas, the system comprising:
a plurality of said cell transceivers and cell antennas;
a transceiver signal combiner/separator coupled to the plurality of transceivers and to a signal bearer to combine transceiver output signals from the transceivers for output onto the signal bearer and to separate combined transceiver input signals received from the bearer for input to the transceivers;
a signal bearer coupled to the combiner/separator to carry the combined transceiver input and output signals between the transceivers and each cell; and
a plurality of cell signal combiner/separators, each coupled to the signal bearer and to a said cell antenna, to combine a signal received at the cell antenna with other signals on the signal bearer received at other cell antennas to provide said combined transceiver input signals, and to separate a transmit signal for the cell antenna from said combined transceiver output signals.

45. A system as claimed in claim 44, further comprising a digital interface device interfaced with each said cell transceiver to provide a common physical interface to a data network shared by transceivers of different cellular communications networks.

46. A system as claimed in claim 45, wherein the signal bearer is configured to provide redundant signal paths between a transceiver and a said cell.

47. A system as claimed in claim 46, wherein said transceiver signal combiner/splitter comprises an optical multiplexer/demultiplexer.

48. A system as claimed in claim 44, further comprising a signal combiner/splitter having a first interface comprising a plurality of first signal lines and a second interface comprising at least one second signal line, the plurality of first signal lines being coupled to a subset of said transceivers and the second signal line being coupled to said combiner/separator; the combiner/splitter combining output signals from the subset of transceivers on the first signal lines and providing a combined output signal on the second signal line, and receiving an input signal on the second signal line and outputting versions of the received input signal on the first signal lines for reception by the transceivers.

49. A system as claimed in claim 44, wherein said signal bearer additionally carries television signals.

50. A system as claimed in claim 44, for use with a GSM cellular communications network.

51. A system as claimed in claim 44, for use with an IMT-2000 cellular communications network.

52. A cellular communications sub-system comprising a plurality of transceivers each serving a respective cell, each cell having a cell antenna;
characterised in that
the transceivers for a plurality of said cells are substantially co-located, and in that the system further comprises:
transceiver interface means to combine rf interfaces of a plurality of the transceivers into a combined signal interface;
transport means to transport signals between the combined signal interface and two or more of said cells; and
coupling means to selectively couple signals between said transport means and each said cell antenna.

53. A cellular communications sub-system as claimed in claim 52, wherein said transport means comprises optical signal transport means.

54. A cellular communications sub-system as claimed in claim 53, wherein said optical signal transport means is configured for transporting a supplementary high bandwidth data service.

55. A cellular communications sub-system as claimed in claim 52, wherein said transceiver interface means and said coupling means both include a bi-directional interface for, respectively, said transceivers and said transport means.

56. A cellular communications sub-system as claimed in claim 55, wherein said transceiver interface means and said coupling means each comprise a signal combiner and a signal selector.

57. A signal distribution system for distributing signals for a wireless communications network in which a geographical area covered by the network is divided into cells, the system comprising:
a first wireless transmitter to provide a first signal output for serving a first cell;
a second wireless transmitter to provide a second signal output for serving a second cell;
a multiplexer having inputs coupled to the first and second wireless transmitters to receive the first and second signal outputs from the transmitters and having an output, to multiplex the received transmitter outputs onto a multiplexed output signal;
a signal transporter coupled to the multiplexer output to transport the multiplexed signal to first and second cell sites; and
a first signal selector at the first cell, coupled to the signal transporter to select a first signal from the multiplexed signal corresponding to the signal output from the first transmitter, for serving the first cell.

58. A signal distribution system as claimed in claim 57, further comprising a second signal selector at the second cell, coupled to the signal transporter to select a second signal from the multiplexed signal corresponding to the signal output from the second transmitter, for serving the second cell.

59. A signal distribution system as claimed in claim 58, further comprising first and second wireless antennas at the first and second cells; means coupled to the reception antennas and to the signal transporter to multiplex signals received from the first and second reception antennas onto the signal transporter; and a demultiplexer to demultiplex the first and second receiver signals and to provide the demultiplexed signals to third and fourth receivers serving the first and second cells.

60. A signal distribution system as claimed in claim 57, wherein said signal transporter forms part of a signal transport network providing a domestic analogue and/or digital data transport service.

61. A signal transmission system for transmitting signals between a plurality of transmitters and/or receivers and a corresponding plurality of antennas, each antenna serving a separate cell of a cellular communications system, the signal transmission system comprising a fibre optic cable for coupling the transmitters and/or receivers and corresponding antennas, characterised in that:
the fibre optic cable includes a loop; and in that
the system further comprises a monitor to monitor integrity of signal transmission on the cable loop and a switch responsive to the monitor to reverse a direction of signal transmission on the cable loop and/or to select an end of the cable loop for reception of signals from a cell of the communication system in response to the monitor signalling that the integrity of signal transmission is or has been adversely affected.

62. A signal transmission system as claimed in claim 61, comprising a plurality of said transmitters and a corresponding plurality of said receivers and wherein said fibre optic cable comprises a first fibre for transmitting signals for said transmitters, and a second fibre for transmitting signals for said receivers.

63. A signal transmission system as claimed in claim 62, wherein a said monitor is located at a cell and the switch is located remotely from the monitor, the system further comprising means for transmitting a monitoring signal from the monitor to the switch.

64. A signal distribution system for a GSM mobile communications network comprising a digital communications network, at least one Base Station Controller (BSC) and a plurality of Base Transceiver Stations (BTSs), each Base Transceiver Station having a digital interface coupled to the Base Station Controller via the digital communications network, characterised in that:
the system further comprises a common digital interface device to the digital communications network; and in that
each of the Base Transceiver Stations is coupled to the common interface device to provide a shared digital connection for the Base Transceiver Stations to the Base Station Controller.

65. A signal distribution system as claimed in claim 64, further comprising signal transportation means for transporting signals to and from a said BTS or Node B to a cell site antenna over a cable TV signal distribution network.

66. A signal distribution system for a IMT-2000 mobile communications network comprising a digital communications network, at least one Radio Network Controller (RNC) and a plurality of Node Bs, each Node B having a digital interface coupled to the Radio Network Controller via the digital communications network, characterised in that:
the system further comprises a common digital interface device to the digital communications network; and in that
each of the Node Bs is coupled to the common interface device to provide a shared digital connection for the Node Bs to the Radio Network Controller.

67. A signal distribution system as claimed in claim 66, further comprising signal transportation means for transporting signals to and from a said BTS or Node B to a cell site antenna over a cable TV signal distribution network.

68. A signal distribution system as claimed in claim 11, 18, 65 or 67 or a method as claimed in claim 28 or 31, wherein cable TV signals are carried in a first fibre optical transmission band and communications network signals are carried in a second fibre optic transmission band, separate from the first band.
